(19) United States
(12) Patent Application Publication
(10) Pub. No.: US 2026/0335999 A1
(43) Pub. Date: Oct. 29, 2026

(54) MACHINE TOOL, CONTROL METHOD, AND PROGRAM

(71) Applicant: NIDEC MACHINE TOOL CORPORATION, Shiga (JP)

(72) Inventors: Kazuyuki ISHIZU, Ritto-shi (JP); Satoshi HIRATA, Ritto-shi (JP); Koichi MASUO, Ritto-shi (JP); Keisuke OBATA, Ritto-shi (JP)

(73) Assignee: NIDEC MACHINE TOOL CORPORATION, Shiga (JP)

(21) Appl. No.: 19/647,391

(22) Filed: Apr. 14, 2026

(30) Foreign Application Priority Data
Apr. 16, 2025 (JP) 2025-067589

(51) Int. Cl. B23F 3/00; B23Q 11/08; B23Q 15/14; G05B 19/18

(52) U.S. Cl. CPC B23F 3/00; B23Q 11/0891; B23Q 15/14; G05B 19/186

(57) ABSTRACT

A machine tool includes a first processing machine including a first tool configured to process a workpiece including a plurality of tooth portions and a first movement mechanism configured to move the first tool, and a control device configured to control the first processing machine. The first tool includes a tool body rotatable around a center axis, a sensor configured to detect phases of the plurality of tooth portions, and a sensor mounting portion located further on one side in an axial direction of the center axis than the tool body and to which the sensor is mounted. The control device is able to execute a detection process of controlling the first processing machine to detect the phases of the plurality of tooth portions by the sensor, and a processing process of controlling the first processing machine based on a result of the detection process and processing the workpiece by the first tool. In the detection process, the control device sets a posture of the first tool to a first posture. In the processing process, the control device sets the posture of the first tool to a second posture. The second posture is a posture in which the center axis is inclined with respect to an up-down direction. The first posture is a posture in which the center axis is inclined with respect to a horizontal direction.

### CROSS-REFERENCE TO RELATED APPLICATIONS

The present invention claims priority under 35 U.S.C. § 119 to Japanese Patent Application No. 2025-067589 filed on Apr. 16, 2025, the entire content of which is incorporated herein by reference.

### TECHNICAL FIELD

The present disclosure relates to a machine tool, a control method, and a program.

### BACKGROUND

A machine tool is known in which a processing machine including a tool is housed in a housing.

In the machine tool as described above, it has been desired to be able to improve the workability of an operator who performs operation using the machine tool and an operator who performs operation such as maintenance on the machine tool.

### SUMMARY

A machine tool according to one aspect of the present disclosure is a machine tool configured to perform gear cutting on a workpiece, the machine tool including: a first processing machine including a first tool configured to process the workpiece including a plurality of tooth portions and a first movement mechanism configured to move the first tool; a housing including a first housing portion in which the first processing machine is housed; and a control device configured to control the first processing machine. The first tool includes: a tool body rotatable around a center axis; a sensor configured to detect phases of the plurality of tooth portions; and a sensor mounting portion located further on one side in an axial direction of the center axis than the tool body and to which the sensor is mounted. The control device is able to execute: a detection process of controlling the first processing machine to detect the phases of the plurality of tooth portions by the sensor; and a processing process of controlling the first processing machine based on a result of the detection process and processing the workpiece by the first tool. In the detection process, the control device sets a posture of the first tool to a first posture. In the processing process, the control device sets the posture of the first tool to a second posture. The second posture is a posture in which the center axis is inclined with respect to an up-down direction. The first posture is a posture in which the center axis is inclined with respect to a horizontal direction.

A machine tool according to one aspect of the present disclosure is a machine tool configured to perform gear cutting on a workpiece, the machine tool including: a first support portion being able to support the workpiece; a second support portion being able to support the workpiece; a first processing machine including a first tool configured to process the workpiece supported by the first support portion;
a second processing machine including a second tool configured to process the workpiece supported by the second support portion; a moving device configured to move the workpiece between a position in which the workpiece is supported by the first support portion and a position in which the workpiece is supported by the second support portion;
a housing in which the first support portion, the second support portion, the first processing machine, the second processing machine, and the moving device are housed; and
a control device configured to control the first processing machine and the second processing machine. The housing includes: a first housing portion in which the first processing machine is housed; a second housing portion in which the second processing machine is housed; a hole portion provided across a wall portion constituting the first housing portion and a wall portion constituting the second housing portion; and a door member configured to openably close the hole portion. The control device includes: a control device main body; and
an operation panel movable relative to the control device main body.

A control method according to one aspect of the present disclosure is a control method for controlling a machine tool configured to perform gear cutting on a workpiece. The machine tool includes: a first processing machine including a first tool configured to process the workpiece including a plurality of tooth portions and a first movement mechanism configured to move the first tool; a housing including a first housing portion in which the first processing machine is housed; and a control device configured to control the first processing machine. The first tool includes: a tool body rotatable around a center axis; a sensor configured to detect phases of the plurality of tooth portions; and a sensor mounting portion located further on one side in an axial direction of the center axis than the tool body and to which the sensor is mounted. The control method includes: a detection process of controlling the first processing machine to detect the phases of the plurality of tooth portions by the sensor; and a processing process of controlling the first processing machine based on a result of the detection process and processing the workpiece by the first tool. The control method includes: setting a posture of the first tool to a first posture in the detection process; and setting the posture of the first tool to a second posture in the processing process. The second posture is a posture in which the center axis is inclined with respect to an up-down direction. The first posture is a posture in which the center axis is inclined with respect to a horizontal direction.

A program according to one aspect of the present disclosure allows a computer to execute the control method described above.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view illustrating a machine tool according to one embodiment;

FIG. 2 is a perspective view illustrating the machine tool according to one embodiment, and is a view of the machine tool as viewed from an angle different from that in FIG. 1;

FIG. 3 is a perspective view illustrating the machine tool according to one embodiment, and is a view illustrating a state where a door member is opened;

FIG. 4 is a partial cross-sectional view illustrating the machine tool according to one embodiment;

FIG. 5 is a diagram illustrating a part of the machine tool according to one embodiment, and is a diagram illustrating a part of detection process procedures;

FIG. 6 is a block diagram illustrating a part of the machine tool according to one embodiment;

FIG. 7 is a flowchart illustrating an example of processing procedures of a control device in the machine tool according to one embodiment;

FIG. 8 is a diagram illustrating a part of the machine tool according to one embodiment, and is a diagram illustrating a part of processing process procedures; and

FIG. 9 is a diagram illustrating a part of a machine tool of Comparative Example, and is a diagram illustrating a part of detection process procedures of Comparative Example.

### DETAILED DESCRIPTION

In the drawings, an XYZ coordinate system is illustrated as a three-dimensional orthogonal coordinate system as appropriate. In the XYZ coordinate system, a Z-axis direction is an up-down direction. A side (+Z side) to which an arrow of the Z-axis is directed is an upper side, and a side (−Z side) opposite to the side to which the arrow of the Z-axis is directed is a lower side. In the following description, the Z-axis direction is referred to as an “up-down direction Z”. An X-axis direction and a Y-axis direction are each a horizontal direction orthogonal to the up-down direction. The X-axis direction and the Y-axis direction are directions orthogonal to each other. In the following description, the X-axis direction is referred to as a “front-rear direction X”, and the Y-axis direction is referred to as a “left-right direction Y”. A side (+X side) in the front-rear direction X to which an arrow of the X-axis is directed is referred to as a “front side” and a side (−X side) in the front-rear direction opposite to the side to which the arrow of the X-axis is directed is referred to as a “rear side”. A side (+Y side) in the left-right direction to which the arrow of the Y-axis is directed is referred to as “one side in the left-right direction”, and a side (−Y side) in the left-right direction opposite to the side to which the arrow of the Y-axis is directed is referred to as “the other side in the left-right direction”. In the following embodiment, the front-rear direction X corresponds to a “first horizontal direction”, and the left-right direction Y corresponds to a “second horizontal direction” intersecting the first horizontal direction.

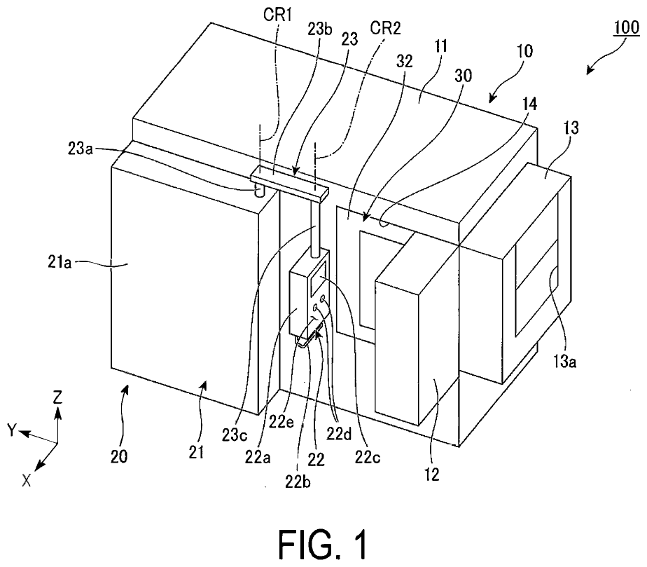

A machine tool 100 of the present embodiment illustrated in FIGS. 1 to 3 is a machine tool configured to perform gear cutting on a workpiece W. More specifically, in the present embodiment, the machine tool 100 manufactures a gear by performing gear cutting and chamfering on the workpiece W. In the present embodiment, the workpiece W is a disk-shaped member in a state before being processed. The workpiece W may be, for example, a columnar member or a cylindrical member in a state before being processed. In the present specification, the expression “a certain member has a disk shape” includes not only a case where the certain member has a strictly disk shape but also a case where the certain member has a substantially disk shape. In the present specification, the expression “a certain member has a columnar shape” includes not only a case where the certain member has a strictly columnar shape but also a case where the certain member has a substantially columnar shape. In the present specification, the expression “a certain member has a cylindrical shape” includes not only a case where the certain member has a strictly cylindrical shape but also a case where the certain member has a substantially cylindrical shape. The workpiece W is made of metal. Gear cutting is processing of cutting a part of the outer circumferential surface of the workpiece W to form a plurality of tooth portions Wa on the workpiece W. Chamfering is processing of chamfering the edges of the plurality of tooth portions Wa. In the present embodiment, the machine tool 100 is an NC machine tool configured to perform processing on the workpiece W based on a numerical control (NC) program.

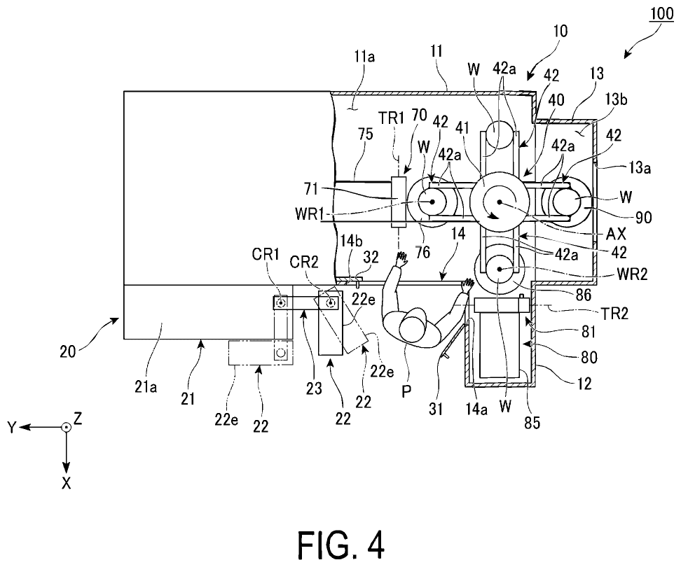

As illustrated in FIGS. 1 to 3, the machine tool 100 includes a housing 10 and a control device 20. As illustrated in FIG. 4, the machine tool 100 includes a moving device 40, a gear cutting machine 70, a chamfering machine 80, a support portion 76, a support portion 86, and a support portion 90. In the present embodiment, the chamfering machine 80 corresponds to a “first processing machine”. The gear cutting machine 70 corresponds to a “second processing machine”. The support portion 86 corresponds to a “first support portion”. The support portion 76 corresponds to a “second support portion”.

The housing 10 houses the moving device 40, the gear cutting machine 70, the chamfering machine 80, and the support portions 76, 86, and 90. As illustrated in FIG. 1, the housing 10 has a substantially rectangular parallelepiped box shape that is long in the left-right direction Y. The housing 10 includes a body portion 11, a protruding housing portion 12, and a replacement portion 13. The body portion 11 is installed on a floor surface. In the present embodiment, the body portion 11 has a substantially rectangular parallelepiped box shape that is long in the left-right direction Y. As illustrated in FIG. 4, the body portion 11 houses the gear cutting machine 70 therein. In other words, in the present embodiment, the body portion 11 corresponds to a “second housing portion” adapted to house therein the gear cutting machine 70 that is the second processing machine.

The protruding housing portion 12 is located on the front side (+X side) of the body portion 11. The protruding housing portion 12 protrudes from the body portion 11 toward the front side (+X side). More specifically, the protruding housing portion 12 protrudes forward from a portion of the body portion 11 on the other side (−Y side) in the left-right direction. The protruding housing portion 12 has a substantially rectangular parallelepiped box shape. The protruding housing portion 12 is open to the rear side (−X side). The internal space of the protruding housing portion 12 is connected to the internal space of the body portion 11 via the opening on the rear side. The protruding housing portion 12 houses the chamfering machine 80 therein. In other words, in the present embodiment, the protruding housing portion 12 corresponds to a “first housing portion” adapted to house therein the chamfering machine 80 that is the first processing machine. As illustrated in FIG. 1, the protruding housing portion 12 extends in the up-down direction Z. A lower end portion of the protruding housing portion 12 is located above a lower end portion of the body portion 11. The protruding housing portion 12 is disposed above and away from the floor surface on which the machine tool 100 is installed.

The replacement portion 13 is located on the other side (−Y side) in the left-right direction of the body portion 11. The replacement portion 13 protrudes from the body portion 11 toward the other side in the left-right direction. The replacement portion 13 has a substantially rectangular parallelepiped box shape. The replacement portion 13 includes an opening portion 13a that opens to the other side in the left-right direction. A lower end portion of the replacement portion 13 is located above the lower end portion of the body portion 11. The replacement portion 13 is disposed above and away from the floor surface on which the machine tool 100 is installed.

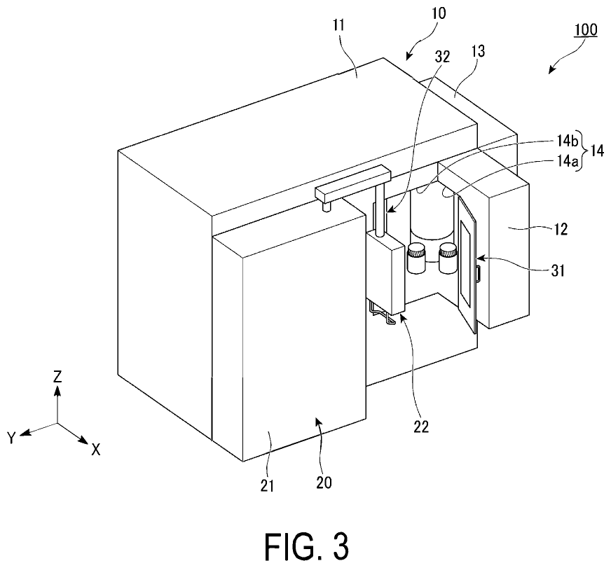

As illustrated in FIG. 3, the housing 10 includes a hole portion 14. The hole portion 14 is provided across a wall portion constituting the body portion 11 and a wall portion constituting the protruding housing portion 12. The hole portion 14 includes a first portion 14a and a second portion 14b. The first portion 14a is a portion of the hole portion 14, which is provided in the wall portion constituting the protruding housing portion 12. The first portion 14a is provided on a wall portion, which is located on one side (+Y side) in the left-right direction, of the wall portion constituting the protruding housing portion 12. The first portion 14a opens to one side in the left-right direction. The first portion 14a has a rectangular shape when viewed in the left-right direction Y. The first portion 14a connects the inside of the protruding housing portion 12 and the outside of the housing 10. The second portion 14b is a portion provided in the wall portion constituting the body portion 11. The second portion 14b is provided on a wall portion, which is located on the front side (+X side), of the wall portion constituting the body portion 11. The second portion 14b opens to the front side. The second portion 14b has a rectangular shape when viewed in the front-rear direction X. The second portion 14b connects the inside of the body portion 11 and the outside of the housing 10. An end portion of the second portion 14b on the other side (−Y side) in the left-right direction is connected to an end portion of the first portion 14a on the rear side (−X side).

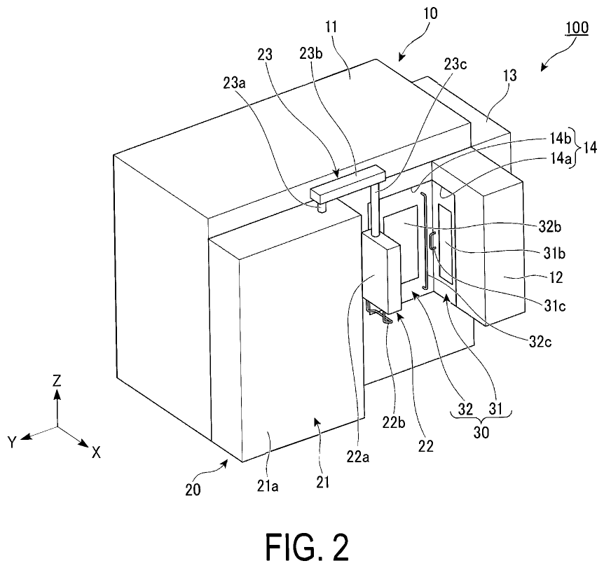

As illustrated in FIG. 2, the housing 10 includes a door member 30 that openably closes the hole portion 14. In the present embodiment, the door member 30 includes a first door portion 31 and a second door portion 32. The first door portion 31 openably closes the first portion 14a. In the present embodiment, the first door portion 31 is a hinged door connected via a hinge (not illustrated) to the edge on the front side (+X side) of the first portion 14a. The first door portion 31 includes a window portion 31b and a handle portion 31c. An operator P can visually recognize the inside of the protruding housing portion 12 through the window portion 31b. The operator P can open the first door portion 31 by pulling the handle portion 31c toward one side (+Y side) in the left-right direction and rotating the first door portion 31 around the hinge (not illustrated).

The second door portion 32 openably closes the second portion 14b. In the present embodiment, the second door portion 32 is a sliding door that is movable in the left-right direction Y. The second door portion 32 includes a window portion 32b and a handle portion 32c. The operator P can visually recognize the inside of the body portion 11 through the window portion 32b. The operator P can open the second door portion 32 by pulling the handle portion 32c toward one side (+Y side) in the left-right direction and moving the second door portion 32 toward one side in the left-right direction. FIG. 2 illustrates a state where both the first door portion 31 and the second door portion 32 are closed. FIG. 3 illustrates a state where both the first door portion 31 and the second door portion 32 are opened. The “operator P” includes an operator who performs operation by using the machine tool 100, an operator who performs operation such as maintenance on the machine tool 100, and the like.

The moving device 40 is a device that can move the workpiece W. As illustrated in FIG. 4, the moving device 40 is located inside the body portion 11. The moving device 40 includes a rotor 41 and a plurality of handle portions 42. The rotor 41 is located in a portion on the other side (−Y side) in the left-right direction inside the body portion 11. The rotor 41 is rotatable around a rotation axis AX extending in the up-down direction Z. The plurality of handle portions 42 protrude from the rotor 41 outward in radial directions centered on the rotation axis AX. The plurality of handle portions 42 are disposed at equal intervals across the entire circumference in the circumferential direction around the rotation axis AX. In the present embodiment, four handle portions 42 are provided. Each of the handle portions 42 includes a pair of arm portions 42a. The pair of arm portions 42a extend in parallel to each other in a direction orthogonal to the rotation axis AX. The pair of arm portions 42a are disposed opposed to each other in a direction of the radial directions centered on the rotation axis AX, which is orthogonal to both the extension direction of the arm portions 42a and the up-down direction Z. The pair of arm portions 42a can hold the workpiece W by sandwiching the workpiece W between the pair of arm portions 42a. Each of the handle portions 42 is movable in the circumferential direction around the rotation axis AX by rotation of the rotor 41 around the rotation axis AX.

In the present embodiment, the moving device 40 can move the workpiece W between a position in which the workpiece W is supported by the support portion 76, a position in which the workpiece W is supported by the support portion 86, and a position in which the workpiece W is supported by the support portion 90 by rotation of the rotor 41 around the rotation axis AX. In the present embodiment, the rotor 41 rotates counterclockwise around the rotation axis AX when viewed from above.

The support portion 76, the support portion 86, and the support portion 90 can support the workpiece W. In the present embodiment, the disk-shaped workpiece W is supported by each of the support portions 76, 86, and 90 in a state where the plate surface faces the up-down direction Z. In other words, in the present embodiment, the workpiece W is supported by each support portion 76, 86, 90 in a state where the center line of the disk-shaped workpiece W extends in the up-down direction Z. Note that when the workpiece W has a columnar shape, a cylindrical shape, or the like, the workpiece W is supported by each support portion 76, 86, 90 in a state where the center line of the columnar or cylindrical workpiece W extends in the up-down direction Z. In the following description, the center line of the disk-shaped, columnar, or cylindrical workpiece W may be simply referred to as the center line of the workpiece W. The support portion 76 is located inside the body portion 11. The support portion 76 protrudes upward from a bottom portion 11a of the body portion 11. The bottom portion 11a is a wall portion located on the lower side of the wall portions constituting the body portion 11. The support portion 76 is located on one side (+Y side) in the left-right direction Y intersecting the front-rear direction X with respect to the moving device 40. The workpiece W carried by the handle portion 42 is placed on the upper side of the support portion 76. The support portion 76 supports the workpiece W from below. The support portion 76 supports the workpiece W at a position in which the workpiece W can be processed by the gear cutting machine 70. The support portion 76 is rotatable around a rotation axis WR1 extending in the up-down direction Z. The center line of the workpiece W supported by the support portion 76 coincides with the rotation axis WR1. The workpiece W supported by the support portion 76 rotates around the rotation axis WR1 as the support portion 76 rotates around the rotation axis WR1.

The support portion 86 protrudes upward from the bottom portion 11a of the body portion 11. The support portion 86 is located on one side (front side, +X side) in the front-rear direction X with respect to the moving device 40. A part of a front portion of the support portion 86 is located inside the protruding housing portion 12. The entire support portion 86 may be located inside the body portion 11. The workpiece W carried by the handle portion 42 is placed on the upper side of the support portion 86. The support portion 86 supports the workpiece W from below. The support portion 86 supports the workpiece W at a position in which the workpiece W can be processed by the chamfering machine 80. The support portion 86 is rotatable around a rotation axis WR2 extending in the up-down direction Z. The center line of the workpiece W supported by the support portion 86 coincides with the rotation axis WR2. The workpiece W supported by the support portion 86 rotates around the rotation axis WR2 as the support portion 86 rotates around the rotation axis WR2.

The support portion 90 protrudes upward from a bottom portion 13b of the replacement portion 13. The bottom portion 13b is a wall portion located on the lower side of the wall portions constituting the replacement portion 13. The support portion 90 is located on the other side (−Y side) in the left-right direction Y with respect to the moving device 40. The support portion 90 and the support portion 76 sandwich the rotor 41 of the moving device 40 in the left-right direction Y. The workpiece W carried by the handle portion 42 and the workpiece W replaced by the operator P are placed on the upper side of the support portion 90. The support portion 90 supports the workpiece W from below. The operator P can take out the workpiece W supported by the support portion 90 to the outside of the machine tool 100 through the opening portion 13a. The operator P can support a new workpiece W on the support portion 90 through the opening portion 13a and arrange the workpiece W with respect to the machine tool 100.

The gear cutting machine 70 is a processing machine configured to perform gear cutting on the workpiece W supported by the support portion 76. The gear cutting machine 70 is located inside the body portion 11. The gear cutting machine 70 includes a gear cutting tool 71 and a movement mechanism 75. In the present embodiment, the gear cutting tool 71 corresponds to a “second tool”. The movement mechanism 75 corresponds to a “second movement mechanism” configured to move the gear cutting tool 71 that is the second tool.

The gear cutting tool 71 is a tool for performing gear cutting on the workpiece W supported by the support portion 76. The gear cutting tool 71 is, for example, a hob cutter. In the present embodiment, the gear cutting tool 71 is rotated around a first center axis TR1 extending in a direction intersecting the up-down direction Z, thereby performing gear cutting on the workpiece W rotating around the rotation axis WR1 while being supported by the support portion 76. At the time of processing the workpiece W by the gear cutting tool 71, the first center axis TR1 extends in the front-rear direction X as viewed in the up-down direction Z. At the time of processing the workpiece W by the gear cutting tool 71, the first center axis TR1 extends in a direction inclined at a predetermined turning angle in the up-down direction Z with respect to the front-rear direction X. The plurality of tooth portions Wa are formed on the outer circumferential surface of the workpiece W by gear cutting. The outer circumferential surface of the workpiece W is a surface of the surfaces of the workpiece W, which is on the outer side in the radial direction centered on the center line of the workpiece W.

The movement mechanism 75 moves the gear cutting tool 71. The movement mechanism 75 can move the gear cutting tool 71 in the front-rear direction X, the left-right direction Y, and the up-down direction Z. The movement mechanism 75 can also rotate the gear cutting tool 71 around an axis (not illustrated) extending in the left-right direction Y. The movement mechanism 75 can adjust the turning angle of the gear cutting tool 71 during gear cutting. The movement mechanism 75 may be configured in any manner as long as the gear cutting tool 71 can be moved.

The chamfering machine 80 is a processing machine configured to perform chamfering on the workpiece W supported by the support portion 86. The chamfering machine 80 is located inside the protruding housing portion 12. The chamfering machine 80 includes a chamfering tool 81 and a movement mechanism 85. In the present embodiment, the chamfering tool 81 corresponds to a “first tool”. The movement mechanism 85 corresponds to a “first movement mechanism” configured to move the chamfering tool 81 that is the first tool.

The chamfering tool 81 is a tool for chamfering the workpiece W supported by the support portion 86 and including the plurality of tooth portions Wa. The chamfering tool 81 is, for example, a hob cutter. More specifically, the chamfering tool 81 is, for example, a chamfering hob cutter. In the present embodiment, the chamfering tool 81 is rotated around a second center axis TR2 extending in a direction intersecting the up-down direction Z, thereby chamfering the workpiece W rotating around the rotation axis WR2 while being supported by the support portion 86. At the time of chamfering the workpiece W by the chamfering tool 81, the second center axis TR2 extends in the left-right direction Y when viewed in the up-down direction Z. At the time of chamfering the workpiece W by the chamfering tool 81, the second center axis TR2 extends in a direction inclined at a predetermined turning angle in the up-down direction Z with respect to the left-right direction Y. The edges of the plurality of tooth portions Wa of the workpiece W are chamfered by chamfering.

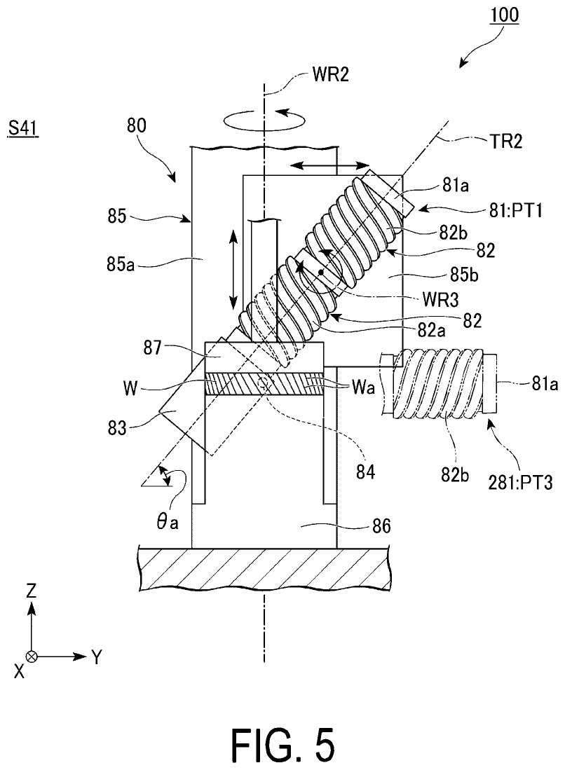

As illustrated in FIG. 5, the chamfering tool 81 includes a base portion 81a, a tool body 82, a sensor mounting portion 83, and a sensor 84. The base portion 81a extends in the axial direction of the second center axis TR2. In the present embodiment, the base portion 81a has a column shape centered on the second center axis TR2. The tool body 82 is provided on the base portion 81a. In the present embodiment, the tool body 82 includes two bodies of a tool body 82a and a tool body 82b that are provided side by side in the axial direction of the second center axis TR2. Each of the two tool bodies 82a and 82b is, for example, a hob cutter centered on the second center axis TR2. The two tool bodies 82a and 82b are disposed with a space therebetween in the axial direction of the second center axis TR2. The base portion 81a and the two tool bodies 82a and 82b are rotatable around the second center axis TR2.

The sensor mounting portion 83 is connected to one end portion of the base portion 81a in the axial direction of the second center axis TR2. The sensor mounting portion 83 is located further on one side in the axial direction of the second center axis TR2 than the tool bodies 82a and 82b. The sensor 84 is mounted to the sensor mounting portion 83.

The sensor 84 can detect the phases of the plurality of tooth portions Wa of the workpiece W. The expression “the sensor 84 can detect the phases of the plurality of tooth portions Wa” means that the control device 20 can acquire the phases of the plurality of tooth portions Wa based on a signal output from the sensor 84. At the time of detecting the phases of the tooth portions Wa, the sensor 84 is located on the outer side of the workpiece W supported by the support portion 86 in the radial direction about the rotation axis WR2 and is opposed to the plurality of tooth portions Wa in the radial direction. The sensor 84 can detect the phases of the plurality of tooth portions Wa by rotation of the workpiece W around the rotation axis WR2 while being opposed to the plurality of tooth portions Wa in the radial direction. In the present embodiment, the sensor 84 is located on the front side (+X side) of the workpiece W, and can detect the phases of the plurality of tooth portions Wa while being opposed to the workpiece W in the front-rear direction X. In the present embodiment, the sensor 84 is a proximity sensor. The sensor 84 is turned into the ON state when being opposed to the tooth portion Wa of the workpiece W rotating around the rotation axis WR2. The sensor 84 is turned into the OFF state when being opposed to a trough portion between the adjacent tooth portions Wa of the workpiece W rotating around the rotation axis WR2. The control device 20 can acquire the phases of the plurality of tooth portions Wa based on the signal output from the sensor 84 and indicating ON/OFF of the sensor 84. The sensor 84 may be any type of sensor as long as the sensor can detect the phases of the plurality of tooth portions Wa.

In the present embodiment, the sensor 84 is disposed at a position shifted from the second center axis TR2 when viewed in the front-rear direction X in which the sensor 84 and the workpiece W are opposed to each other in detection process S41 described below. The sensor 84 is mounted to an end portion of a surface on the rear side (−X side) of the sensor mounting portion 83, the end portion being on a side close to the base portion 81a in the axial direction of the second center axis TR2. The sensor 84 is mounted to an outer end portion of the end portion in the radial direction centered on the second center axis TR2. The sensor 84 is mounted to a portion of the surface on the rear side of the sensor mounting portion 83, the portion being below the second center axis TR2 in processing process S42 described below.

The movement mechanism 85 moves the chamfering tool 81. The movement mechanism 85 can move the chamfering tool 81 in the front-rear direction X, the left-right direction Y, and the up-down direction Z. The movement mechanism 85 can also rotate the chamfering tool 81 around the rotation axis WR3 extending in the front-rear direction X. The rotation axis WR3 passes through the center between the two tool bodies 82a and 82b in the axial direction of the second center axis TR2. The movement mechanism 85 can adjust the turning angle of the chamfering tool 81 during chamfering. The movement mechanism 85 includes a base portion 85a and a movable portion 85b. The base portion 85a is fixed inside the protruding housing portion 12. The chamfering tool 81 is mounted to the movable portion 85b so as to be rotatable around the rotation axis WR3. The movable portion 85b is movable relative to the base portion 85a in the front-rear direction X, the left-right direction Y, and the up-down direction Z. The movable portion 85b moves relative to the base portion 85a, and thus the chamfering tool 81 is moved in the respective directions. The movement mechanism 85 may be configured in any manner as long as the chamfering tool 81 can be moved.

The chamfering machine 80 includes a presser portion 87. The presser portion 87 presses from above the workpiece W supported by the support portion 86. The presser portion 87 rotates around the rotation axis WR2 together with the support portion 86 and the workpiece W. The presser portion 87 is movable in the up-down direction Z.

The control device 20 controls the moving device 40, the gear cutting machine 70, the chamfering machine 80, and the support portions 76 and 86. In the present embodiment, the control device 20 can perform gear cutting and chamfering. As illustrated in FIG. 1, the control device 20 is located on the front side (+X side) of the housing 10. The control device 20 is attached to a portion on one side (+Y side) in the left-right direction of the front surface of the body portion 11. The control device 20 includes a control device main body 21, an operation panel 22, and a coupling portion 23.

The control device main body 21 is located on the front side (+X side) of the housing 10. The control device main body 21 is attached to a portion on one side (+Y side) in the left-right direction of the front surface of the body portion 11. The control device main body 21 and the protruding housing portion 12 are disposed with a space therebetween in the left-right direction Y. The control device main body 21 is located on one side in the left-right direction away from the hole portion 14. The control device main body 21 has a rectangular parallelepiped shape. The dimension of the control device main body 21 in the front-rear direction X is smaller than the dimension of the protruding housing portion 12 in the front-rear direction X. The front surface of the control device main body 21 is located further on the rear side (−X side) than the front surface of the protruding housing portion 12. The control device main body 21 includes a case 21a. The case 21a has a rectangular parallelepiped box shape. The case 21a is attached to a portion on one side in the left-right direction of the front surface of the body portion 11. The front surface of the case 21a is the front surface of the control device main body 21.

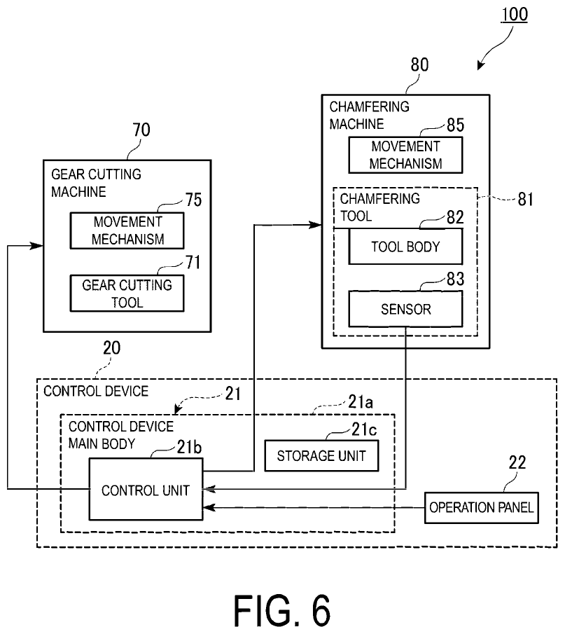

As illustrated in FIG. 6, the control device main body 21 includes a control unit 21b and a storage unit 21c. The control unit 21b and the storage unit 21c are housed inside the case 21a. The control unit 21b is a processor such as a central processing unit (CPU). The control unit 21b is a unit configured to execute a program that allows each device to perform processing on the workpiece W. The program is stored in the storage unit 21c.

The operation panel 22 is operated by the operator P when the operator P uses the machine tool 100, when the operator P performs operation such as maintenance on the machine tool 100, and the like. As illustrated in FIG. 1, the operation panel 22 is attached via the coupling portion 23 to the control device main body 21. The operation panel 22 is movable relative to the control device main body 21. The operation panel 22 includes an operation panel body portion 22a and a handle portion 22b.

In the present embodiment, the operation panel body portion 22a has a substantially rectangular parallelepiped shape. The operation panel body portion 22a includes a display unit 22c and a plurality of operation units 22d. Information related to processing to be performed by the machine tool 100 and the like are displayed on the display unit 22c. The plurality of operation units 22d are units to be operated by the operator P. The plurality of operation units 22d include an operation unit 22d to be operated when the gear cutting tool 71 is removed from the gear cutting machine 70, an operation portion 22d to be operated when the chamfering tool 81 is removed from the chamfering machine 80, and the like. The operation unit 22d is, for example, a button to be pressed by the operator P. The display unit 22c and the operation units 22d are provided on one of surfaces of the operation panel body portion 22a. The surface on which the display unit 22c and the operation units 22d are provided is an operation surface 22e. The handle portion 22b is attached to the lower surface of the operation panel body portion 22a. The operator P can move the operation panel 22 relative to the control device main body 21 by gripping the handle portion 22b and pushing or pulling the handle portion 22b.

The coupling portion 23 couples the control device main body 21 and the operation panel 22. The coupling portion 23 includes a first shaft portion 23a, an arm portion 23b, and a second shaft portion 23c. The first shaft portion 23a protrudes upward from the upper surface of the control device main body 21. More specifically, the first shaft portion 23a protrudes upward from an end portion on the other side (−Y side) in the left-right direction of the upper surface of the control device main body 21. The first shaft portion 23a has a column shape centered on a rotation axis CR1 extending in the up-down direction Z. The arm portion 23b is connected to an upper end portion of the first shaft portion 23a. The arm portion 23b extends from the upper end portion of the first shaft portion 23a toward the outer side in the radial direction centered on the rotation axis CR1. The arm portion 23b is rotatable around the rotation axis CR1. The second shaft portion 23c has a column shape centered on a rotation axis CR2 and extending in the up-down direction Z. The second shaft portion 23c extends downward from the lower surface of the arm portion 23b. An upper end portion of the second shaft portion 23c is connected to an outer end portion of the arm portion 23b in the radial direction about the rotation axis CR1. A lower end portion of the second shaft portion 23c is connected to the operation panel 22. The arm portion 23b and the operation panel 22 are rotatable relative to each other about the rotation axis CR2.

In the example of FIGS. 1 to 4, the operation panel 22 is located between the control device main body 21 and the protruding housing portion 12 in the left-right direction Y. In the examples of FIGS. 1 to 4, the posture of the operation panel 22 is a posture in which the operation surface 22e faces to the other side (−Y side) in the left-right direction. In the examples of FIGS. 1 to 4, the operation panel 22 is disposed at a position overlapping the hole portion 14 when viewed in the left-right direction Y. In other words, in the present embodiment, the operation panel 22 is movable to a position overlapping the hole portion 14 when viewed in the left-right direction Y in which the first portion 14a of the hole portion 14, which is provided in the wall portion constituting the protruding housing portion 12 extends through the wall portion constituting the protruding housing portion 12. In the present embodiment, the operation panel 22 is movable to a position overlapping the first portion 14a when viewed in the left-right direction Y. As indicated by the two dot chain line in FIG. 4, the operation panel 22 is movable to a position located on the front side (+X side) of the control device main body 21. When being located on the front side of the control device main body 21, the operation panel 22 can be in a posture in which the operation surface 22e faces to the front side. As indicated by the two dot chain line in FIG. 4, the operation panel 22 can be in a posture in which the operation surface 22e is inclined in the front-rear direction X with respect to a surface orthogonal to the left-right direction Y between the control device main body 21 and the protruding housing portion 12 in the left-right direction Y.

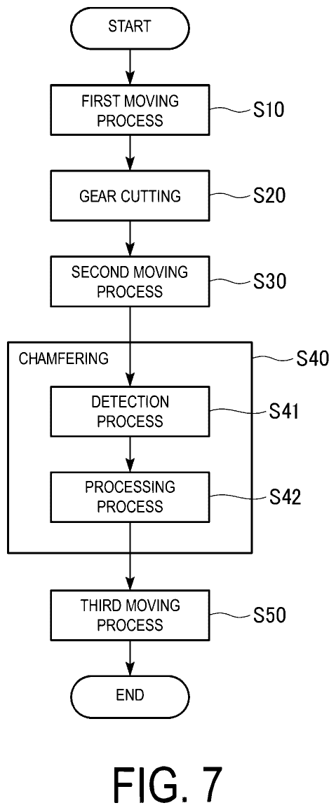

In the present embodiment, the control device 20 executes a control method of the machine tool 100 according to the flowchart of FIG. 7. The control method according to the present embodiment is executed by the control unit 21b. As illustrated in FIG. 7, the control device 20 executes first moving process S10. In the first moving process S10, the control device 20 allows the unprocessed workpiece W placed on the support portion 90 by the operator P to be moved by the moving device 40 to the support portion 76 thereabove, and allows the workpiece W to be supported by the support portion 76.

After the first moving process S10, the control device 20 executes gear cutting S20. In the gear cutting S20, the control device 20 controls the gear cutting machine 70 to perform gear cutting on the workpiece W supported by the support portion 76. Accordingly, the plurality of tooth portions Wa are formed on the workpiece W. After the gear cutting S20, the control device 20 executes second moving process S30. In the second moving process S30, the control device 20 allows the workpiece W to be moved by the moving device 40 to the support portion 86 thereabove, and allows the workpiece W to be supported by the support portion 86. In the second moving process S30 according to the present embodiment, the control device 20 allows the presser portion 87 to move down and press from above the workpiece W supported by the support portion 86.

After the second moving process S30, the control device 20 executes chamfering S40. The chamfering S40 includes the detection process S41 and the processing process S42. In other words, the control device 20 can execute the detection process S41 and the processing process S42, and the control method according to the present embodiment includes the detection process S41 and the processing process S42. The detection process S41 is a process of controlling the chamfering machine 80 and detecting the phases of the plurality of tooth portions Wa of the workpiece W by the sensor 84. As illustrated in FIG. 5, in the detection process S41, the control device 20 sets the posture of the chamfering tool 81 to a first posture PT1. In other words, the control method according to the present embodiment includes setting the posture of the chamfering tool 81 to the first posture PT1 in the detection process S41. The first posture PT1 is a posture in which the second center axis TR2 is inclined with respect to the left-right direction Y that is the horizontal direction. In the present embodiment, an inclination θa of the second center axis TR2 with respect to the left-right direction Y in the first posture PT1 is 40° or more. The inclination θa is 70° or less. The inclination θa is, for example, about 50°. The values of the inclination θa are absolute values. The inclination θa is not particularly limited as long as the inclination θa is larger than 0°. In the first posture PT1, the chamfering tool 81 is located on the lower side toward the other side (−Y side) in the left-right direction. The first posture PT1 is a posture in which the chamfering tool 81 is inclined in the up-down direction Z with respect to the left-right direction Y such that the sensor mounting portion 83 is lowered with respect to the tool body 82.

In the first posture PT1, the second center axis TR2 extends in the left-right direction Y when viewed in the up-down direction Z. In other words, in the detection process S41, the control device 20 sets the posture of the chamfering tool 81 to a posture in which the second center axis TR2 extends in the left-right direction Y intersecting the front-rear direction X when viewed in the up-down direction Z. In addition, the control method according to the present embodiment includes setting, in the detection process S41, the posture of the chamfering tool 81 to a posture in which the second center axis TR2 extends in the left-right direction Y when viewed in the up-down direction Z. In the present embodiment, the first posture PT1 is also a standby posture of the chamfering tool 81. In other words, when the chamfering machine 80 does not perform the chamfering S40, the chamfering tool 81 is in the first posture PT1.

In the detection process S41, the control device 20 aligns the position of the sensor 84 in the left-right direction Y with the position of the rotation axis WR2 in the left-right direction Y, thereby setting the sensor 84 to be opposed to the workpiece W in the front-rear direction X. In the detection process S41, the control device 20 allows the support portion 86 to rotate around the rotation axis WR2 in a state where the sensor 84 is opposed to the workpiece W in the front-rear direction X, and thus the workpiece W is rotated around the rotation axis WR2. Therefore, the control device 20 can acquire, based on the sensor 84, the relative positional relationship between the positions of the plurality of tooth portions Wa in the circumferential direction around the rotation axis WR2 and the trough portions between the tooth portions Wa. Consequently, the control device 20 can detect the phases of the plurality of tooth portions Wa based on the detection result of the sensor 84.

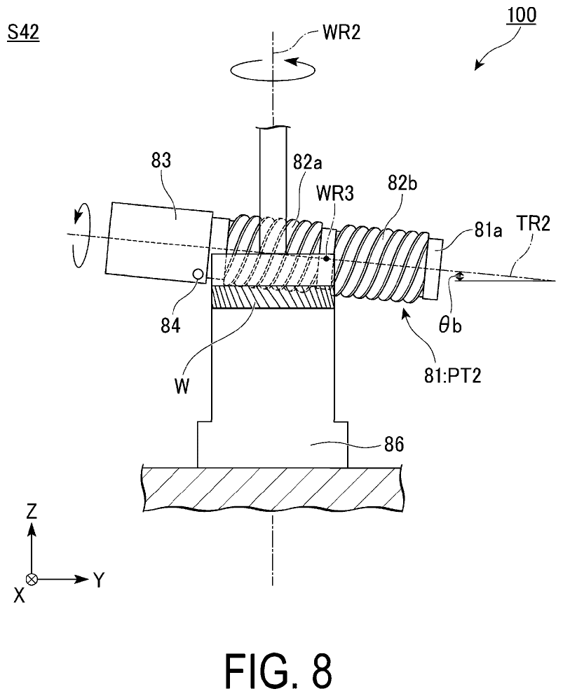

After the detection process S41, the control device 20 executes the processing process S42. The processing process S42 is a process of controlling the chamfering machine 80 based on the result of the detection process S41 and processing the workpiece W by the chamfering tool 81. As illustrated in FIG. 8, in the processing process S42, the control device 20 sets the posture of the chamfering tool 81 to a second posture PT2. In other words, the control method according to the present embodiment includes setting the posture of the chamfering tool 81 to the second posture PT2 in the processing process S42. The second posture PT2 is a posture in which the second center axis TR2 is inclined with respect to the up-down direction Z. In the present embodiment, the second posture PT2 is a posture in which the second center axis TR2 is inclined with respect to the left-right direction Y that is the horizontal direction. An inclination θb of the second center axis TR2 with respect to the left-right direction Y in the second posture PT2 is larger than 0° and smaller than 40°. In the present embodiment, the inclination θb is larger than 0° and smaller than 20°. The inclination θb is, for example, about 10°. The values of the inclination θb are absolute values. The inclination θb is smaller than the inclination θa. In other words, the inclination of the second center axis TR2 with respect to the left-right direction Y in the first posture PT1 is larger than the inclination of the second center axis TR2 with respect to the left-right direction Y in the second posture PT2. In the second posture PT2, the chamfering tool 81 is located on the upper side toward the other side (−Y side) in the left-right direction. The second posture PT2 is a posture in which the chamfering tool 81 is inclined in the up-down direction Z with respect to the left-right direction Y such that the sensor mounting portion 83 is raised upward with respect to the tool body 82. In other words, the first posture PT1 and the second posture PT2 are opposite to each other in the inclination of the chamfering tool 81 in the up-down direction Z with respect to the left-right direction Y.

In the processing process S42, the control device 20 allows the tool body 82 to rotate about the second center axis TR2, and thus chamfering is performed on the plurality of tooth portions Wa of the workpiece W by the tool body 82. In the processing process S42, the control device 20 performs the positional alignment of the tooth portions of the tool body 82 with the tooth portions Wa of the workpiece W based on the phases of the plurality of tooth portions Wa acquired in the detection process S41. In the processing process S42, the control device 20 sequentially performs, for example, chamfering on the edge of each of the tooth portions Wa on the upper side and on one circumferential side, chamfering of the edge of each of the tooth portions Wa on the upper side and on the other circumferential side, chamfering of the edge of each of the tooth portions Wa on the lower side and on one circumferential side, and chamfering of the edge of each of the tooth portions Wa on the lower side and on the other circumferential side, using either one of the tool body 82a and the tool body 82b. By chamfering the plurality of tooth portions Wa, gear cutting on the workpiece W is completed, and the gear is manufactured.

As illustrated in FIG. 7, after the processing process S42, the control device 20 executes third moving process S50. In the third moving process S50, the control device 20 allows the workpiece W completed as the gear to be moved to the support portion 90 thereabove by the moving device 40, and allows the workpiece W to be supported by the support portion 90. The operator P can take out the workpiece W as the completed gear from the machine tool 100 through the opening portion 13a of the replacement portion 13.

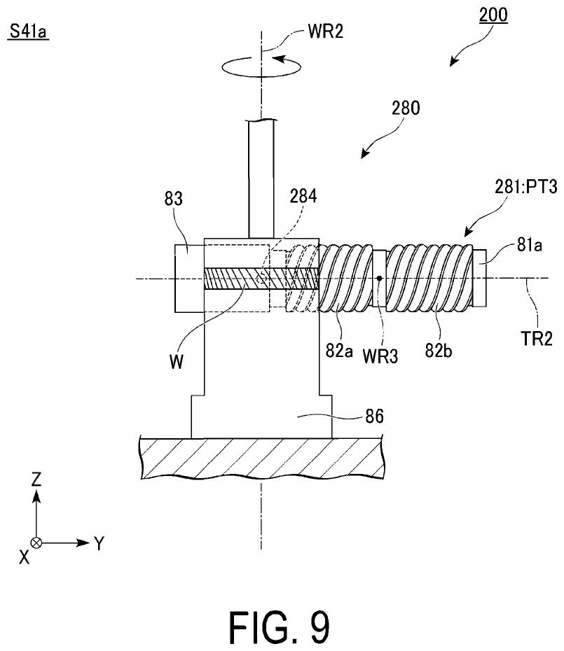

FIG. 9 is a diagram illustrating a part of a machine tool 200 of Comparative Example. FIG. 9 illustrates a case where detection process S41a is executed in the machine tool 200 of Comparative Example. The detection process S41a in the machine tool 200 of Comparative Example is different in the posture of a chamfering tool 281 from the detection process S41 in the machine tool 100 according to the present embodiment. As illustrated in FIG. 9, the chamfering tool 281 of a chamfering machine 280 in the machine tool 200 of Comparative Example is set to a third posture PT3 in the detection process S41a. The third posture PT3 is a posture in which the second center axis TR2 is parallel to the left-right direction Y that is the horizontal direction. In the chamfering tool 281, a sensor 284 is disposed at a position overlapping the second center axis TR2 when viewed in the front-rear direction X. The detection process S41a is the same process as the detection process S41 according to the present embodiment except for the above point.

In the detection process S41a in the machine tool 200 of Comparative Example, the position of the sensor 284 mounted to the sensor mounting portion 83 in the left-right direction Y is also aligned with the position of the rotation axis WR2 in the left-right direction Y. At this time, when the posture of the chamfering tool 281 is the third posture PT3 in which the second center axis TR2 is parallel to the left-right direction Y, the position of the chamfering tool 281 in the left-right direction Y needs to be moved widely in the left-right direction Y compared to the position of the chamfering tool 281 in the left-right direction Y when the processing process S42 is performed. Therefore, the chamfering tool 281 protrudes greatly in the left-right direction Y with respect to the support portion 86 in the detection process S41a, which causes the following problem that the dimension of the protruding housing portion 12 in the left-right direction Y in which the chamfering machine 280 is housed is increased in order to house the chamfering tool 281 therein when performing the detection process S41a. When the dimension of the protruding housing portion 12 in the left-right direction Y is increased, the space around the machine tool 200 becomes narrow, which causes the following problem that it becomes difficult for the operator P to perform operation. Specifically, for example, the distance between the protruding housing portion 12 and the control device main body 21 in the left-right direction Y is reduced, which causes the following problem that it becomes difficult for the operator P to perform operation between the protruding housing portion 12 and the control device main body 21 in the left-right direction Y.

In order to solve the above problems, according to the present embodiment, the control device 20 sets the posture of the chamfering tool 81 to the first posture PT1 in the detection process S41. The first posture PT1 is a posture in which the second center axis TR2 is inclined with respect to the left-right direction Y that is the horizontal direction. Therefore, as illustrated in FIG. 5, the chamfering tool 81 can be disposed to be inclined with respect to the left-right direction Y in the detection process S41, and the dimension of the chamfering tool 81 in the left-right direction Y in the detection process S41 can be reduced compared to the dimension in a case where the posture of the chamfering tool 81 is the third posture PT3. This can prevent the chamfering tool 81 from protruding greatly in the left-right direction Y with respect to the support portion 86 in the detection process S41. Specifically, in the present embodiment, in the detection process S41, the end portion of the chamfering tool 81, which is on the one side (+Y side) in the left-right direction can be positioned further on the other side (−Y side) in the left-right direction than the chamfering tool 281 in the third posture PT3 indicated by the two dot chain line in FIG. 5. This can reduce the dimension in the left-right direction Y of the protruding housing portion 12 in which the chamfering machine 80 is housed. Specifically, in the present embodiment, the end portion of the protruding housing portion 12, which is on one side in the left-right direction can be positioned further on the other side in the left-right direction than the machine tool 200 of Comparative Example. As described above, the protruding housing portion 12 can be downsized in the left-right direction Y, and thus a wide space for the operator P to perform operation can be easily secured around the machine tool 100. Specifically, in the present embodiment, as illustrated in FIG. 4, the distance between the control device main body 21 and the protruding housing portion 12 in the left-right direction Y can be increased, and the operator P can easily perform operation between the control device main body 21 and the protruding housing portion 12 in the left-right direction Y. Therefore, in the machine tool 100, the workability of the operator P can be improved. In addition, since the protruding housing portion 12 can be downsized, the manufacturing cost of the housing 10 can be reduced. Therefore, the manufacturing cost of the machine tool 100 can be reduced.

In the present embodiment, the inclination θa of the second center axis TR2 with respect to the left-right direction Y in the first posture PT1, that is, the inclination θa with respect to the horizontal direction is larger than the inclination θb of the second center axis TR2 with respect to the left-right direction Y in the second posture PT2. Therefore, the inclination θa can be easily increased, and the dimension of the chamfering tool 81 in the left-right direction Y in the first posture PT1 can be further reduced. As a result, the protruding housing portion 12 can be easily downsized in the left-right direction Y, and the workability of the operator P can be further improved. In addition, the manufacturing cost of the machine tool 100 can be further reduced.

In the present embodiment, the inclination θa of the second center axis TR2 with respect to the left-right direction Y in the first posture PT1, that is, the horizontal direction, is 40° or more. Therefore, the inclination θa can be more suitably increased, and the dimension of the chamfering tool 81 in the left-right direction Y in the first posture PT1 can be more suitably reduced. As a result, the protruding housing portion 12 can be easily and more suitably downsized in the left-right direction Y, and the workability of the operator P can be more suitably improved. In addition, the manufacturing cost of the machine tool 100 can be more suitably reduced.

The closer the inclination θa is to 90°, the smaller the dimension of the chamfering tool 81 in the left-right direction Y in the first posture PT1 is. However, if the inclination θa is excessively large, it is difficult to perform wiring routing in the chamfering machine 80. Also, if the inclination θa is excessively large, the amount of movement of the chamfering tool 81 moved when shifting from the detection process S41 to the processing process S42 increases. Therefore, the accuracy of tooth meshing performed using the phases of the plurality of tooth portions Wa in the processing process S42 may decrease. In contrast, in the present embodiment, the inclination θa is 70° or less. This can prevent the difficulty in wiring routing in the chamfering machine 80, and can prevent a decrease in the accuracy of tooth meshing in the processing process S42.

In the present embodiment, the sensor 84 is disposed at a position shifted from the second center axis TR2 when viewed in the front-rear direction X in which the sensor 84 and the workpiece W are opposed to each other in the detection process S41. For example, in the first posture PT1, when the sensor 84 is disposed at a position overlapping the second center axis TR2 of the sensor mounting portion 83 when viewed in the front-rear direction X, the position of the sensor 84 in the left-right direction Y is further on the other side (−Y side) in the left-right direction than the position of the sensor 84 in the left-right direction Y illustrated in FIG. 5. In this case, when the position of the sensor 84 in the front-rear direction X is to be aligned with the rotation axis WR2 in the first posture PT1, the chamfering tool 81 needs to be moved to one side (+Y side) in the left-right direction from the position illustrated in FIG. 5. In contrast, by disposing the sensor 84 at a position shifted from the second center axis TR2 when viewed in the front-rear direction X as in the present embodiment, the amount of movement of the chamfering tool 81 to one side in the left-right direction can be reduced. Therefore, the wall portion of the protruding housing portion 12 on one side in the left-right direction can be easily set further on the other side in the left-right direction, and the protruding housing portion 12 can be further downsized in the left-right direction Y.

In the present embodiment, the support portion 86 that the first support portion is located on one side (+X side) of the moving device 40 in the front-rear direction X that is the first horizontal direction. The support portion 76 that is the second support portion is located on one side (+Y side) of the moving device 40 in the left-right direction Y that is the second horizontal direction. In the detection process S41, the control device 20 sets the posture of the chamfering tool 81 to a posture in which the second center axis TR2 extends in a direction intersecting the front-rear direction X when viewed in the up-down direction Z. When the support portion 76 and the support portion 86 are disposed as described above, the operator P may perform operation such as maintenance on the inner side of a corner portion formed by the body portion 11 and the protruding housing portion 12 as illustrated in FIG. 4. In the present embodiment, as described above, the protruding housing portion 12 can be downsized in the left-right direction Y in which the second center axis TR2 extends when viewed in the up-down direction Z. Therefore, the space on the inner side of the corner formed by the body portion 11 and the protruding housing portion 12 can be widened, and the workability of the operator P can be further improved.

In the present embodiment, the housing 10 includes the hole portion 14 provided across the wall portion constituting the protruding housing portion 12 that is the first housing portion and the wall portion constituting the body portion 11, and the door member 30 that openably closes the hole portion 14. Therefore, the operator P can open the hole portion 14 by opening the door member 30. The hole portion 14 is provided across the protruding housing portion 12 and the body portion 11, and a pillar or the like that partitions the protruding housing portion 12 and the body portion 11 is not provided in the hole portion 14. Therefore, the operator P can easily perform operation on both the chamfering machine 80 in the protruding housing portion 12 and the gear cutting machine 70 in the body portion 11 through the opened hole portion 14. Consequently, the workability of the operator P can be further improved. Specifically, the operator P can easily perform maintenance operation of the chamfering tool 81, replacement operation of the chamfering tool 81, maintenance operation of the gear cutting tool 71, replacement operation of the gear cutting tool 71, and the like through the hole portion 14.

In the present embodiment, the door member 30 includes the first door portion 31 that openably closes the first portion 14a of the hole portion 14, which is provided in the wall portion constituting the protruding housing portion 12, and the second door portion 32 that openably closes the second portion 14b of the hole portion 14, which is provided in the wall portion constituting the body portion 11. Therefore, the hole portion 14 can be easily closed in an openable manner by two door portions as compared to a case where the hole portion 14 is closed in an openable manner by one door portion. In addition, when the operator P performs operation only on one of the inside of the protruding housing portion 12 and the inside of the body portion 11, the operator P can perform the operation by opening only one of the door portions without unnecessarily exposing the inside of the machine tool 100.

In the present embodiment, the control device 20 includes the control device main body 21 and the operation panel 22 movable relative to the control device main body 21. Therefore, the operator P can move the operation panel 22 to a position in which the operator P can easily perform operation. As a result, the workability of the operator P can be further improved. For example, when removing the chamfering tool 81 and the gear cutting tool 71, the operator P needs to operate the operation panel 22. The operator P moves the operation panel 22 to a location near the hole portion 14, and thus the operator P can easily operate the operation panel 22 and each tool without changing his/her posture. Therefore, the workability in removing each tool can be improved.

As just described, the hole portion 14 is provided across the wall portion constituting the protruding housing portion 12 and the wall portion constituting the body portion 11, and the operation panel 22 is movable relative to the control device main body 21, and thus the workability of the operator P can be suitably improved.

In the present embodiment, the operation panel 22 is movable to a position overlapping the hole portion 14 when viewed in the left-right direction Y in which the first portion 14a of the hole portion 14, which is provided in the wall portion constituting the protruding housing portion 12 extends through the wall portion constituting the protruding housing portion 12. Therefore, the operator P who performs operation through the hole portion 14 can easily move the operation panel 22 to a position in which the operator P can easily operate the operation panel 22. Consequently, the workability of the operator P can be further improved.

In the present embodiment, the first tool of the first processing machine housed in the protruding housing portion 12 that is the first housing portion is the chamfering tool 81 for chamfering the workpiece W. Therefore, the protruding housing portion 12 in which the chamfering machine 80 that performs chamfering is housed can be easily downsized. As a result, the workability of the operator P on the chamfering machine 80 can be improved.

The control device 20 is a computer configured to execute the control method according to the present embodiment described above. A program for causing the control device 20, which is a computer, to execute the control method described above is installed in the control device 20. The program is, for example, stored in the storage unit 21c and executed by the control unit 21b. At least a part of the functions of the control device 20 is implemented, for example, by executing the program stored in the storage unit 21c, that is, software. The program may be stored in a storage unit different from the storage unit 21c. The control device 20 may include a plurality of portions or devices each having a part of the functions of the control device 20.

At least a part of the functions of the control device 20 may be implemented by hardware including a circuit unit such as a large scale integration (LSI), an application specific integrated circuit (ASIC), a field-programmable gate array (FPGA), and a central processing unit (CPU), or may be implemented by software and hardware in cooperation. The storage unit 21c in which the program for causing the control device 20, which is a computer, to execute the control method according to the present embodiment described above is stored is implemented by a storage medium such as a random access memory (RAM), a read only memory (ROM), a hard disk drive (HDD), and a flash memory. The storage unit 21c is not particularly limited as long as the storage unit can store a program that causes the control device 20 to execute the control method according to the present embodiment described above. The storage unit 21c may be a microcomputer or may be a disk media such as a CD-ROM. The storage unit 21c may be provided separately from the control device 20. In this case, the control device 20 may communicate with the storage unit 21c through wired communication or wireless communication and execute the program stored in the storage unit 21c.

The present disclosure is not limited to the above-described embodiments, and other configurations and methods can be adopted within the scope of the technical idea of the present disclosure. The machine tool according to the present disclosure may be a machine tool configured to perform processing other than gear cutting as long as the machine tool performs processing on a workpiece. Examples of processing other than gear cutting include cutting, grinding, polishing, and marking (engraving) for manufacturing a component other than a gear. Cutting includes, for example, drilling.

The first tool may be any tool as long as the tool is a tool for performing processing on a workpiece. When the first tool is a tool for processing a workpiece including a plurality of tooth portions, the first tool may be a tool other than a chamfering tool, such as a tool for performing polishing processing of polishing the plurality of tooth portions. The first tool may be a tool used for processing other than gear cutting. The second tool may be any tool as long as the tool is a tool for performing processing on a workpiece. The second tool may be, for example, a tool for performing grinding processing for grinding the plurality of tooth portions. The second tool may be a tool used for processing other than gear cutting. The second processing machine having the second tool does not need to be provided.

In the detection process, the control device may set the posture of the first tool to any posture. In the detection process, the control device may set the posture of the first tool to a posture in which the center axis is parallel to the horizontal direction. The inclination of the center axis of the first tool with respect to the horizontal direction in the first posture may be the same as the inclination of the center axis of the first tool with respect to the horizontal direction in the second posture, or may be smaller than the inclination of the center axis of the first tool with respect to the horizontal direction in the second posture. In the processing process, the control device may set the posture of the first tool to any posture. In the processing process, the control device may set the posture of the first tool to a posture in which the center axis is parallel to the up-down direction. The operation panel of the control device does not need to be movable relative to the control device main body. When the housing includes the hole portion provided across the wall portion constituting the first housing portion and the wall portion constituting the second housing portion, the door member that openably closes the hole portion may include one door portion. The housing does not need to include the hole portion provided across the wall portion constituting the first housing portion and the wall portion constituting the second housing portion.

Note that the present technology can have configurations such as the following.

(1) A machine tool configured to perform gear cutting on a workpiece, the machine tool including: a first processing machine including a first tool configured to process the workpiece including a plurality of tooth portions and a first movement mechanism configured to move the first tool; a housing including a first housing portion in which the first processing machine is housed; and a control device configured to control the first processing machine, wherein the first tool includes: a tool body rotatable around a center axis; a sensor configured to detect phases of the plurality of tooth portions; and a sensor mounting portion located further on one side in an axial direction of the center axis than the tool body and to which the sensor is mounted, the control device is able to execute: a detection process of controlling the first processing machine to detect the phases of the plurality of tooth portions by the sensor; and a processing process of controlling the first processing machine based on a result of the detection process and processing the workpiece by the first tool, in the detection process, the control device sets a posture of the first tool to a first posture, in the processing process, the control device sets the posture of the first tool to a second posture, the second posture is a posture in which the center axis is inclined with respect to an up-down direction, and the first posture is a posture in which the center axis is inclined with respect to a horizontal direction.

(2) The machine tool according to (1), wherein an inclination of the center axis with respect to the horizontal direction in the first posture is larger than an inclination of the center axis with respect to the horizontal direction in the second posture.

(3) The machine tool according to (2), wherein the inclination of the center axis with respect to the horizontal direction in the first posture is 40° or more.

(4) The machine tool according to any one of (1) to (3), wherein the sensor is disposed at a position shifted from the center axis as viewed in a direction in which the sensor and the workpiece are opposed to each other in the detection process.

(5) The machine tool according to any one of (1) to (4), including: a first support portion being able to support the workpiece; a second support portion being able to support the workpiece; a second processing machine including a second tool configured to process the workpiece supported by the second support portion and a second movement mechanism configured to move the second tool; and a moving device configured to move the workpiece between a position in which the workpiece is supported by the first support portion and a position in which the workpiece is supported by the second support portion, wherein the first tool is a tool configured to process the workpiece supported by the first support portion, the first support portion is located on one side of the moving device in a first horizontal direction, the second support portion is located on one side of the moving device in a second horizontal direction intersecting the first horizontal direction, and in the detection process, the control device sets the posture of the first tool to a posture in which the center axis extends in a direction intersecting the first horizontal direction when viewed in the up-down direction.

(6) The machine tool according to (5), wherein the housing includes: a second housing portion in which the second processing machine is housed; a hole portion provided across a wall portion constituting the first housing portion and a wall portion constituting the second housing portion; and a door member configured to openably close the hole portion.

(7) The machine tool according to (6), wherein the door member includes: a first door portion configured to openably close a portion of the hole portion, which is provided in the wall portion constituting the first housing portion; and a second door portion configured to openably close a portion of the hole portion, which is provided in the wall portion constituting the second housing portion.

(8) The machine tool according to (6) or (7), wherein the control device includes: a control device main body; and
an operation panel movable relative to the control device main body.

(9) A machine tool configured to process a workpiece, the machine tool including: a first support portion being able to support the workpiece; a second support portion being able to support the workpiece; a first processing machine including a first tool configured to process the workpiece supported by the first support portion; a second processing machine including a second tool configured to process the workpiece supported by the second support portion; a moving device configured to move the workpiece between a position in which the workpiece is supported by the first support portion and a position in which the workpiece is supported by the second support portion; a housing in which the first support portion, the second support portion, the first processing machine, the second processing machine, and the moving device are housed; and a control device configured to control the first processing machine and the second processing machine, wherein the housing includes: a first housing portion in which the first processing machine is housed; a second housing portion in which the second processing machine is housed; a hole portion provided across a wall portion constituting the first housing portion and a wall portion constituting the second housing portion; and a door member configured to openably close the hole portion, and
the control device includes: a control device main body; and
an operation panel movable relative to the control device main body.

(10) The machine tool according to (8) or (9), wherein the operation panel is movable to a position overlapping the hole portion when viewed in a direction in which a portion of the hole portion, which is provided in the wall portion constituting the first housing portion extends through the wall portion constituting the first housing portion.

(11) The machine tool according to any one of (1) to (10), wherein the first tool is a chamfering tool configured to chamfer the workpiece.

(12) A control method for controlling a machine tool configured to perform gear cutting on a workpiece, the machine tool including: a first processing machine including a first tool configured to process the workpiece including a plurality of tooth portions and a first movement mechanism configured to move the first tool; a housing including a first housing portion in which the first processing machine is housed; and a control device configured to control the first processing machine, wherein the first tool includes: a tool body rotatable around a center axis; a sensor configured to detect phases of the plurality of tooth portions; and
a sensor mounting portion located further on one side in an axial direction of the center axis than the tool body and to which the sensor is mounted, the control method includes: a detection process of controlling the first processing machine to detect the phases of the plurality of tooth portions by the sensor; and a processing process of controlling the first processing machine based on a result of the detection process and processing the workpiece by the first tool, in the detection process, the control device sets a posture of the first tool to a first posture, in the processing process, the control device sets the posture of the first tool to a second posture,
the second posture is a posture in which the center axis is inclined with respect to an up-down direction, and the first posture is a posture in which the center axis is inclined with respect to a horizontal direction.

(13) The control method according to (12), wherein an inclination of the center axis with respect to the horizontal direction in the first posture is larger than an inclination of the center axis with respect to the horizontal direction in the second posture.

(14) The control method according to (13), wherein the inclination of the center axis with respect to the horizontal direction in the first posture is 40° or more.

(15) The control method according to (13) or (14), wherein the machine tool includes: a first support portion being able to support the workpiece; a second support portion being able to support the workpiece; a second processing machine including a second tool configured to process the workpiece supported by the second support portion and a second movement mechanism configured to move the second tool; and a moving device configured to move the workpiece between a position in which the workpiece is supported by the first support portion and a position in which the workpiece is supported by the second support portion, wherein the first tool is a tool configured to process the workpiece supported by the first support portion, the first support portion is located on one side of the moving device in a first horizontal direction,
the second support portion is located on one side of the moving device in a second horizontal direction intersecting the first horizontal direction, and the control method includes, in the processing process, setting the posture of the first tool to a posture in which the center axis extends in a direction intersecting the first horizontal direction when viewed in the up-down direction.

(16) The control method according to any one of (13) to (15), wherein the first tool is a chamfering tool configured to chamfer the workpiece.

(17) A program for causing a computer to execute the control method according to any one of (12) to (16).

The configurations and methods described above in the present specification can be combined as appropriate within a range in which they do not contradict each other.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A machine tool configured to perform gear cutting on a workpiece, the machine tool comprising:
a first processing machine including a first tool configured to process the workpiece including a plurality of tooth portions and a first movement mechanism configured to move the first tool;
a housing including a first housing portion in which the first processing machine is housed; and
a control device configured to control the first processing machine, wherein the first tool includes:
a tool body rotatable around a center axis;
a sensor configured to detect phases of the plurality of tooth portions; and
a sensor mounting portion located further on one side in an axial direction of the center axis than the tool body and to which the sensor is mounted,
the control device is able to execute:
a detection process of controlling the first processing machine to detect the phases of the plurality of tooth portions by the sensor; and
a processing process of controlling the first processing machine based on a result of the detection process and processing the workpiece by the first tool,
in the detection process, the control device sets a posture of the first tool to a first posture,
in the processing process, the control device sets the posture of the first tool to a second posture,
the second posture is a posture in which the center axis is inclined with respect to an up-down direction, and
the first posture is a posture in which the center axis is inclined with respect to a horizontal direction.

2. The machine tool according to claim 1, wherein an inclination of the center axis with respect to the horizontal direction in the first posture is larger than an inclination of the center axis with respect to the horizontal direction in the second posture.

3. The machine tool according to claim 2, wherein the inclination of the center axis with respect to the horizontal direction in the first posture is 40° or more.

4. The machine tool according to claim 1, wherein the sensor is disposed at a position shifted from the center axis as viewed in a direction in which the sensor and the workpiece are opposed to each other in the detection process.

5. The machine tool according to claim 1, comprising:
a first support portion being able to support the workpiece;
a second support portion being able to support the workpiece;
a second processing machine including a second tool configured to process the workpiece supported by the second support portion and a second movement mechanism configured to move the second tool; and
a moving device configured to move the workpiece between a position in which the workpiece is supported by the first support portion and a position in which the workpiece is supported by the second support portion, wherein
the first tool is a tool configured to process the workpiece supported by the first support portion,
the first support portion is located on one side of the moving device in a first horizontal direction,
the second support portion is located on one side of the moving device in a second horizontal direction intersecting the first horizontal direction, and
in the detection process, the control device sets the posture of the first tool to a posture in which the center axis extends in a direction intersecting the first horizontal direction when viewed in the up-down direction.

6. The machine tool according to claim 5, wherein the housing includes:
a second housing portion in which the second processing machine is housed;
a hole portion provided across a wall portion constituting the first housing portion and a wall portion constituting the second housing portion; and
a door member configured to openably close the hole portion.

7. The machine tool according to claim 6, wherein the door member includes:
a first door portion configured to openably close a portion of the hole portion, which is provided in the wall portion constituting the first housing portion; and
a second door portion configured to openably close a portion of the hole portion, which is provided in the wall portion constituting the second housing portion.

8. The machine tool according to claim 6, wherein the control device includes:
a control device main body; and
an operation panel movable relative to the control device main body.

9. A machine tool configured to process a workpiece, the machine tool comprising:
a first support portion being able to support the workpiece;
a second support portion being able to support the workpiece;
a first processing machine including a first tool configured to process the workpiece supported by the first support portion;
a second processing machine including a second tool configured to process the workpiece supported by the second support portion;
a moving device configured to move the workpiece between a position in which the workpiece is supported by the first support portion and a position in which the workpiece is supported by the second support portion;
a housing in which the first support portion, the second support portion, the first processing machine, the second processing machine, and the moving device are housed; and
a control device configured to control the first processing machine and the second processing machine, wherein
the housing includes:
a first housing portion in which the first processing machine is housed;
a second housing portion in which the second processing machine is housed;
a hole portion provided across a wall portion constituting the first housing portion and a wall portion constituting the second housing portion; and
a door member configured to openably close the hole portion, and
the control device includes:
a control device main body; and
an operation panel movable relative to the control device main body.

10. The machine tool according to claim 8, wherein the operation panel is movable to a position overlapping the hole portion when viewed in a direction in which a portion of the hole portion, which is provided in the wall portion constituting the first housing portion extends through the wall portion constituting the first housing portion.

11. The machine tool according to claim 1, wherein the first tool is a chamfering tool configured to chamfer the workpiece.

12. A control method for controlling a machine tool configured to perform gear cutting on a workpiece, the machine tool comprising:
a first processing machine including a first tool configured to process the workpiece including a plurality of tooth portions and a first movement mechanism configured to move the first tool;
a housing including a first housing portion in which the first processing machine is housed; and
a control device configured to control the first processing machine, wherein the first tool includes:
a tool body rotatable around a center axis;
a sensor configured to detect phases of the plurality of tooth portions; and
a sensor mounting portion located further on one side in an axial direction of the center axis than the tool body and to which the sensor is mounted,
the control method comprises:
a detection process of controlling the first processing machine to detect the phases of the plurality of tooth portions by the sensor; and
a processing process of controlling the first processing machine based on a result of the detection process and processing the workpiece by the first tool,
in the detection process, the control device sets a posture of the first tool to a first posture,
in the processing process, the control device sets the posture of the first tool to a second posture,
the second posture is a posture in which the center axis is inclined with respect to an up-down direction, and
the first posture is a posture in which the center axis is inclined with respect to a horizontal direction.

13. The control method according to claim 12, wherein an inclination of the center axis with respect to the horizontal direction in the first posture is larger than an inclination of the center axis with respect to the horizontal direction in the second posture.

14. The control method according to claim 13, wherein the inclination of the center axis with respect to the horizontal direction in the first posture is 40° or more.

15. The control method according to claim 13, wherein the machine tool comprises:
a first support portion being able to support the workpiece;
a second support portion being able to support the workpiece;
a second processing machine including a second tool configured to process the workpiece supported by the second support portion and a second movement mechanism configured to move the second tool; and
a moving device configured to move the workpiece between a position in which the workpiece is supported by the first support portion and a position in which the workpiece is supported by the second support portion, wherein
the first tool is a tool configured to process the workpiece supported by the first support portion,
the first support portion is located on one side of the moving device in a first horizontal direction,
the second support portion is located on one side of the moving device in a second horizontal direction intersecting the first horizontal direction, and
the control method comprises, in the processing process, setting the posture of the first tool to a posture in which the center axis extends in a direction intersecting the first horizontal direction when viewed in the up-down direction.

16. The control method according to claim 13, wherein the first tool is a chamfering tool configured to chamfer the workpiece.

17. A program for causing a computer to execute the control method according to claim 12.
